(19) United States
(12) Patent Application Publication
(10) Pub. No.: US 2022/0315468 A1
(43) Pub. Date: Oct. 6, 2022

(54) TREATMENT METHOD OF WASTEWATER CONTAINING HIGH-CONCENTRATION BORON

(71) Applicant: Taiwan Power Company, Taipei (TW)

(72) Inventors: Yi-Chang CHANG, Taipei (TW); Cheng-You WU, Taipei (TW); Shu-Wei CHANG, Taipei (TW)

(21) Appl. No.: 17/697,383

(22) Filed: Mar. 17, 2022

(30) Foreign Application Priority Data
Mar. 31, 2021 (TW) 110111969

(51) Int. Cl. C02F 9/00; C04B 18/06; C04B 28/02

(52) U.S. Cl. CPC C02F 9/00; C04B 18/065; C04B 18/062; C04B 28/02; C02F 1/66

(57) ABSTRACT

A treatment method of wastewater containing high-concentration boron includes steps as follows: pouring wastewater containing high-concentration boron into a PH value adjusting tank; pouring an alkaline solution into the PH value adjusting tank; pouring the wastewater containing boron into a boron-removing electrocoagulation tank, and an electric conducting electrolyte being provided for performing an electrocoagulation procedure; discharging sludge generated by the electrocoagulation procedure into a boron-contained sludge dewatering tank; outputting the wastewater containing boron into a first absorbing tank provided with a first absorbing material to perform an absorbing and filtering procedure; outputting the wastewater containing boron into a second absorbing tank provided with a second absorbing material to perform another absorbing and filtering procedure; and outputting the wastewater containing boron into a filtering tank to perform another filtering procedure for outputting the wastewater containing boron with a lower concentration.

### BACKGROUND OF THE INVENTION

### Field of the Invention

The present invention relates to a treatment method of wastewater containing boron, especially to a treatment method of wastewater containing high-concentration boron.

### Description of the Related Art

Boron in the natural world often exists in groundwater, and the source thereof is rocks and soils containing borate. The boron exists in a water solution as free boron B(OH)₃, and as B(OH)₄⁻ in a water solution with a higher PH value.

Most boron in the world exists in the ocean, and a concentration thereof greatly varies in different areas, the actual concentration is determined through the ambient geological condition and the discharging amount of wastewater, and the average concentration is 4.5 mg/L. If a person exposes in an environment with high-concentration of boron, a minor syndrome may be vomiting and a major syndrome may be shock and even dead, and the high-concentration of boron would also be toxic to plants which causes the plants poorly grow.

In the manufacturing procedure of a high tech industry, for example an electronic industry or an optoelectronic industry, a raw material or a testing agent containing high-concentration boron are required. As such, wastewater containing boron generated in the manufacturing procedure has to be effectively removed for complying with a water discharging standard. In a coal-fired power plant, the chloride concentration and the containing amount of salt are high in wastewater from limestone-plaster wet desulfurization system and unable to be processed in the power plant, thus a comprehensive purifying treatment is hard to achieve, and the wastewater becomes the most difficult material to be processed in the power plant.

Wastewater in a wet fuel-gas desulfurization has a boron concentration greater than 600 mg/L, and according to the environmental protecting regulation, only the wastewater with a boron concentration less than 5 mg/L after being treated complied with the water discharging standard. As such, the desulfurization wastewater has to be processed inside a factory to comply with the discharging standard. For the wastewater containing boron, treatment methods adopted in the related industries include: a chemical precipitation method, a method of selective ion exchange resin, a reverse osmosis membrane treating method, an electrocoagulation method and an absorbent method.

Wherein, treating the wastewater containing high-concentration boron with the chemical precipitation method requires a large consuming amount of chemical reagents and has problems such as dealing with the precipitations. The method of selective ion exchange resin allows the boron concentration in the water after being processed to satisfy requirements of drinking water and irrigation water, but problems such as recycling treatment of saturated resin and having recycled wastewater containing high-concentration boron are caused. The technology of reverse osmosis membrane faces a major problem of a high PH value of treated water is generated during an initial treatment process, and shortages such as the reverse osmosis membrane being damaged, the membrane being polluted and the reverse osmosis concentrated water being required for another treatment are caused. The electrocoagulation method is able to perform a treatment to wastewater containing high-concentration boron and has a higher boron removing rate and a better economic benefit comparing to a chemical coagulation method, but problems of consuming electrode plates, consuming energy and the treatment of precipitated sludge should be concerned in an actual application. As such, how to develop a method of utilizing a waste material as an absorbent for improving the high cost for treating and recycling the conventional absorbent, for example active carbon or metal oxide, shall be an important issue to be researched.

Take Taiwan Patent NO.1531543, titled in “Method for treatment of boron-containing wastewater” as an example; wherein a method for treatment of boron-containing wastewater is disclosed, boron absorbed in a negative ion exchange resin sub-material is eluted by acid or alkaline or recycled to obtain a discharged concentration higher than 500 mg/L, the wastewater containing boron is added with aluminum salt (aluminum chlorohydrate) and a PH adjusting agent to form a reaction solution with insoluble precipitate distributed therein; and with a solid-liquid separating step, the insoluble precipitate in the reaction solution is separated for allowing treated water to be obtained.

Take Taiwan Patent NO.1540103, titled in “Method for removing boron from boron-containing wastewater” as an example, wherein a PH value of the boron-containing wastewater is adjusted to a PH value between 8˜14, a coagulant containing barium compound is added for reactions, the formed solid boron salt suspended particles are processed with a solid-liquid separating procedure, so as to obtain a liquid containing less boron concentration and a treatment method of discharged water containing boron in sludge containing boron.

Take Taiwan Patent NO.1577443, titled in “Inorganic for removing harmful substances in wastewater and method for fabricating the same and method of treating wastewater”, wherein a plurality of porous silicate particles with glass phase structure are utilized, the composition includes silica, alumina, baryta, strontia and boron oxide; wherein, an average aperture of the porous silicate particles is between 3˜50 nano, and a zeta potential of the porous silicate particles under an environment with a PH value between 1˜5 is a negative value. Wastewater containing harmful substances is fed in a fluidized bed reactor having carriers, so that the harmful substances in the wastewater are crystalized on the carriers, thereby removing the harmful substances and obtaining treated wastewater.

Take Taiwan Patent NO.1594955, titled in “Method for treating high-concentration of boron-containing wastewater” as an example, a pre-treatment step by utilizing hydrogen peroxide is processed to control a PH value to be between 8˜12, and then mix with barium compound to generate pexborate precipitation.

Take Taiwan Patent NO.1612014, titled in “Method for treating boron-containing wastewater using fluidized bed homogeneous granulation technique” as an example, wherein a method a fluidized bed reacting tank being added with compound containing calcium coagulant and hydrogen peroxide is adopted.

Moreover, take Taiwan Patent NO.1637917, titled in “Fluoride removal method of fuel-gas desulfurization wastewater and fluoride removal system thereof” as an example, wherein a fluoride removal method of fuel-gas desulfurization wastewater is disclosed, which includes steps of: (a) electrocoagulation and (b) stirring and mixing, wherein the step (a) is processed in an electrocoagulation device, the electrocoagulation device is disposed with a power supplier capable of increasing a high-frequency pulse current, and in the step (b) of stirring and mixing, alkaline is added to adjust a PH value of the wastewater to be between PH 5˜8.

However, the above-mentioned patents do not disclose using a direct-current power source provided by an energy storage battery or solar power, using coal ashes as an absorbent for accelerating an electrocoagulation treatment to wastewater containing boron, and solidifying the coal ashes to form a concomitant concrete product.

Accordingly, the present invention provides a novel treatment method of wastewater containing high-concentration boron.

### SUMMARY OF THE INVENTION

One primary objective of the present invention is to provide a treatment method of wastewater containing high-concentration boron, in which an energy storage battery or solar power is used as a DC power source, coal ashes are used as an absorbent for accelerating a treatment to wastewater containing high-concentration boron, and the coal ashes can be solidified to form a concomitant concrete product.

For achieving said objectives, one technical solution provided by the present invention is to provide a treatment method of wastewater containing high-concentration boron, which includes steps as follows: pouring wastewater containing high-concentration boron into a PH value adjusting tank; pouring an alkaline solution into the PH value adjusting tank to adjust a PH value of the wastewater containing high-concentration boron; pouring the wastewater containing boron after the PH value being adjusted into a boron-removing electrocoagulation tank, and an electric conducting electrolyte being provided for performing an electrocoagulation procedure; discharging sludge generated by the electrocoagulation procedure from a bottom portion of the tank into a boron-contained sludge dewatering tank for dewatering; outputting the wastewater containing boron processed by the electrocoagulation procedure into a first absorbing tank, and a first absorbing material being provided into the first absorbing tank to perform an absorbing and filtering procedure on the wastewater containing boron; outputting the wastewater containing boron after being filtered through the first absorbing tank into a second absorbing tank, and a second absorbing material being provided into the second absorbing tank to perform another absorbing and filtering procedure on the wastewater containing boron; and outputting the wastewater containing boron after being absorbed and filtered through the second absorbing tank into a filtering tank to perform another filtering procedure for outputting the wastewater containing boron with a lower concentration.

Wherein, the wastewater containing high-concentration boron is wastewater of fuel-gas desulfurization generated by a coal-fired power plant, and the boron concentration thereon is 500 mg/L.

Wherein, the alkaline solution is NaOH, and a PH value, after being adjusted, of the wastewater containing high-concentration boron is 8˜10.

Wherein, the electric conducting electrolyte is seawater for increasing an electric conductivity of the wastewater containing high-concentration boron and reducing power consumption during the electrocoagulation procedure.

Wherein, a power source adopted in the boron-removing electrocoagulation tank is a direct-current power source with 30˜1000V, and the direct-current is from an energy storage battery or solar power.

Wherein, the boron-removing electrocoagulation tank further has an electrode, and the electrode is pure aluminum, nickel, iron or an alloy consisted of pure aluminum, nickel and iron.

Wherein, the first absorbing material is bottom ash, and when a providing amount thereof is 100˜500 g/L, an absorbing period 20˜180 minutes.

Wherein, the filtering tank further has ultrafine hollow fibers with less than 0.5 micron as a filtering material, which is used for purifying the wastewater after being processed by the electrocoagulation procedure.

Wherein, the second absorbing material is fly ash, and when a providing amount thereof is 100˜500 g/L, an absorbing period 20˜180 minutes.

Wherein, the first absorbing tank, the filtering tank and the second absorbing tank absorb saturated coal ashes which are provided in the boron-contained sludge dewatering tank, and a binder is provided after the dewatering procedure; the binder is, for example but not limited to, cement, so that a concrete product containing coal ashes is formed.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is a flowchart illustrating a treatment method of wastewater containing high-concentration boron according to one preferred embodiment of the present invention.

### DETAILED DESCRIPTION OF THE PREFERRED EMBODIMENTS

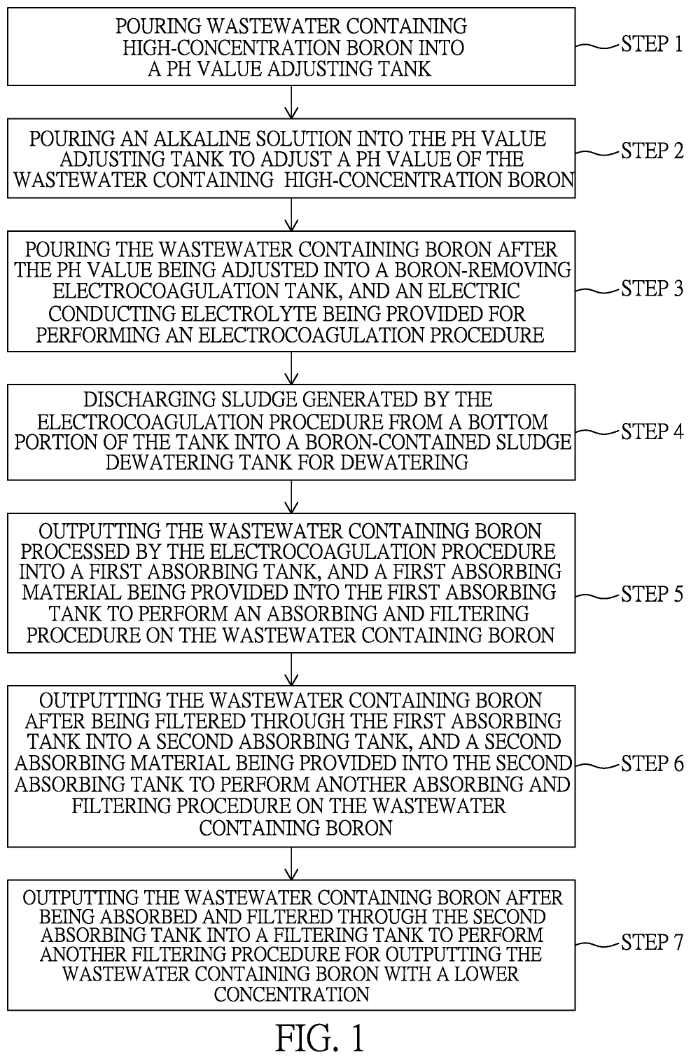

Please refer to FIG. 1, which is a flowchart illustrating a treatment method of wastewater containing high-concentration boron according to one preferred embodiment of the present invention

As show in FIG. 1, the present invention provides a treatment method of wastewater containing high-concentration boron, which including steps as follows: pouring wastewater containing high-concentration boron into a PH value adjusting tank (a step 1); pouring an alkaline solution into the PH value adjusting tank to adjust a PH value of the wastewater containing high-concentration boron (a step 2); pouring the wastewater containing boron after the PH value being adjusted into a boron-removing electrocoagulation tank, and an electric conducting electrolyte being provided for performing an electrocoagulation procedure (a step 3); discharging sludge generated by the electrocoagulation procedure from a bottom portion of the tank into a boron-contained sludge dewatering tank for dewatering (a step 4); outputting the wastewater containing boron processed by the electrocoagulation procedure into a first absorbing tank, and a first absorbing material being provided into the first absorbing tank to perform an absorbing and filtering procedure on the wastewater containing boron (a step 5); outputting the wastewater containing boron after being filtered through the first absorbing tank into a second absorbing tank, and a second absorbing material being provided into the second absorbing tank to perform another absorbing and filtering procedure on the wastewater containing boron (a step 6); outputting the wastewater containing boron after being absorbed and filtered through the second absorbing tank into a filtering tank to perform another filtering procedure for outputting the wastewater containing boron with a lower concentration (a step 7).

In the step 1, the wastewater containing high-concentration boron is poured into the PH value adjusting tank. Wherein, the wastewater containing high-concentration boron is, for example but not limited to, wastewater of fuel-gas desulfurization generated by a coal-fired power plant, and the boron concentration thereon is, for example but not limited to, 500 mg/L.

In the step 2, the alkaline solution is poured into the PH value adjusting tank to adjust the PH value of the wastewater containing high-concentration boron. Wherein, the alkaline solution is, for example but not limited to, NaOH, and the PH value, after being adjusted, of the wastewater containing high-concentration boron is, for example but not limited to, PH8˜10.

In the step 3, the wastewater containing boron after the PH value being adjusted is poured into the boron-removing electrocoagulation tank, and the electric conducting electrolyte is provided for performing the electrocoagulation procedure. Wherein, the electric conducting electrolyte is, for example but not limited to, seawater, so that the electric conductivity of the wastewater containing high-concentration boron is increased, and power consumption during the electrocoagulation procedure is reduced. Wherein, the boron-removing electrocoagulation tank further has an electrode, and the electrode is, for example but not limited to, pure aluminum, nickel, iron or an alloy consisted of pure aluminum, nickel and iron.

In the step 4, the sludge generated by the electrocoagulation procedure from the bottom portion of the tank is discharged into the boron-contained sludge dewatering tank for dewatering. Wherein, a power source adopted in the boron-removing electrocoagulation tank is, for example but not limited to, a direct-current power source with 30˜1000V, and the direct-current is from an energy storage battery or solar power.

In the step 5, the wastewater containing boron processed by the electrocoagulation procedure is discharged into the first absorbing tank, and the first absorbing material is provided into the first absorbing tank to perform the absorbing and filtering procedure on the wastewater containing boron. Wherein, when the amount of the first absorbing material, for example but not limited to 100˜500 g/L, is provided, an absorbing period is set to, for example but not limited to 20˜180 minutes.

In the step 6, the wastewater containing boron after being filtered through the first absorbing tank is discharged into the second absorbing tank, and the second absorbing material is provided into the second absorbing tank to perform another absorbing and filtering procedure on the wastewater containing boron. Wherein, when the amount of the second absorbing material, for example but not limited to 100˜500 g/L, is provided, an absorbing period is set to, for example but not limited to 20˜180 minutes.

In the step 7, the wastewater containing boron after being absorbed and filtered through the second absorbing tank is discharged into the filtering tank to perform another filtering procedure for outputting the wastewater containing boron with a lower concentration. Wherein, the filtering tank further has ultrafine hollow fibers with less than 0.5 micron as a filtering material, which is used for purifying the wastewater after being processed by the electrocoagulation procedure.

Moreover, according to the treatment method of wastewater containing high-concentration boron, the first absorbing tank, the filtering tank and the second absorbing tank are able to absorb saturated coal ashes which are provided in the boron-contained sludge dewatering tank, and a binder is provided after the dewatering procedure. Wherein, the binder is, for example but not limited to, cement, so that a concrete product containing coal ashes is formed.

The treatment of wastewater containing high-concentration boron of the present invention is applied in a testing sample of original wastewater containing high-concentration boron generated by the Taipower Company fired power plant located in Taichung, Taiwan, a 40% NaOH is firstly provided to adjust a PH value of the testing sample to PH8˜10, the testing sample is electrolyzed with a constant current for 30 minutes, and filtered through the first absorbing tank and the second absorbing tank, then the PH value is adjusted again and electrolyzed for another 30 minutes, the above-mentioned operations are repeatedly processed for 3 hours, so that the wastewater containing high-concentration boron with a concentration of 600 ppm is lowered to 13 ppm, a removing rate thereof is about 97.8%, meanwhile a magnesium removing rate is 99.55%, and a Calcium removing rate is about 65.2%;

the technical feature disclosed in the present invention is a continuous treatment method to effectively treating a large amount of wastewater containing high-concentration boron, and the operation process is simple, thereby being able to be automated. Accordingly, the treatment method of wastewater containing high-concentration boron provided by the present invention is novel and more practical in use comparing to prior arts.

Based on what has been disclose above, advantages achieved by the treatment method of wastewater containing high-concentration boron disclosed in the present invention, comparing with conventional treatment methods of wastewater containing high-concentration boron, are as follows: 1. the direct-current power source from the energy storage battery or the solar power is adopted; 2. the coal ashes are used as the absorbent for treating the fuel material with wastewater containing high-concentration boron; and 3. the coal ashes can be solidified to form a concomitant concrete product. Accordingly, the treatment method of wastewater containing high-concentration boron provided by the present invention is novel and more practical in use comparing to the conventional treatment methods of wastewater containing high-concentration boron.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures. For example, before going through the electrocoagulation procedure, the wastewater of fuel-gas desulfurization generated by a coal-fired power plant can be poured into a tank containing fly ash and bottom ash and stay still for a period of time to increase the PH level thereof to alkaline values, which can be up to 10. When the PH level becomes more alkaline, more of the magnesium ions (Mg⁺²) in the wastewater of fuel-gas desulfurization will hydrolyze to form Mg(OH)² precipitation. As the magnesium hydroxides can absorb borons, the boron concentration of the wastewater of fuel-gas desulfurization will reduce considerably, thereby reducing the cost of the electrocoagulation procedure. That is, the invention can be embodied alternatively as: pouring wastewater of fuel-gas desulfurization generated by a coal-fired power plant into a first tank containing fly ash and bottom ash and stay still for a period of time to generate first processed wastewater having an alkaline PH level (step A); performing an electrocoagulation procedure on the first processed wastewater in a second tank to generate and discharge second processed wastewater (step B); and using a binder to mix with saturated coal ashes derived from the first tank to generate a concrete product, where the binder can be cement (step C). Besides, in step B, an additional alkaline solution is poured into the second tank to support the electrocoagulation procedure.

In summation of the above description, the present invention herein enhances the performance over the conventional structure and further complies with the patent application requirements and is submitted to the Patent and Trademark Office for review and granting of the commensurate patent rights.

What is claimed is:

1. A treatment method of wastewater containing high-concentration boron, including steps as follows:
pouring wastewater of fuel-gas desulfurization generated by a coal-fired power plant into a first tank containing fly ash and bottom ash and stay still for a period of time to generate first processed wastewater having an alkaline PH level;
performing an electrocoagulation procedure on the first processed wastewater in a second tank to generate and discharge second processed wastewater; and
using a binder to mix with saturated coal ashes derived from the first tank to generate a concrete product.

2. The treatment method of wastewater containing high-concentration boron as claimed in claim 1, wherein the binder is cement.

3. The treatment method of wastewater containing high-concentration boron as claimed in claim 1, wherein an additional alkaline solution is poured into the second tank to accelerate the electrocoagulation procedure.

4. A treatment method of wastewater containing high-concentration boron, including steps as follows:
pouring wastewater containing high-concentration boron into a PH value adjusting tank, wherein said wastewater containing high-concentration boron is wastewater of fuel-gas desulfurization generated by a coal-fired power plant;
pouring an alkaline solution into said PH value adjusting tank to adjust a PH value of said wastewater containing high-concentration boron to generate first processed wastewater;
pouring said first processed wastewater into a boron-removing electrocoagulation tank having an electric conducting electrolyte for performing an electrocoagulation procedure on the first processed wastewater to generate second processed wastewater;
discharging sludge generated by said electrocoagulation procedure from a bottom portion of said boron-removing electrocoagulation tank into a boron-contained sludge dewatering tank for dewatering;
outputting said second processed wastewater into a first absorbing tank having a first absorbing material for performing an absorbing and filtering procedure on said second processed wastewater to generate third processed wastewater, wherein said first absorbing material is bottom ash;
outputting said third processed wastewater into a second absorbing tank having a second absorbing material for performing another absorbing and filtering procedure on said third processed wastewater to generate fourth processed wastewater, wherein said second absorbing material is fly ash; and
outputting said fourth processed wastewater into a filtering tank for performing another filtering procedure on the fourth processed wastewater to provide low boron concentration water;
wherein said first absorbing tank, said filtering tank and said second absorbing tank absorb saturated coal ashes provided in said boron-contained sludge dewatering tank, and a binder is provided to mix with the saturated coal ashes to form a concrete product.

5. The treatment method of wastewater containing high-concentration boron as claimed in claim 4, wherein said wastewater containing high-concentration boron has a boron concentration of 500 mg/L.

6. The treatment method of wastewater containing high-concentration boron as claimed in claim 4, wherein said alkaline solution is NaOH, and a PH value, after being adjusted, of said wastewater containing high-concentration boron is 8˜10.

7. The treatment method of wastewater containing high-concentration boron as claimed in claim 4, wherein said electric conducting electrolyte is seawater for increasing an electric conductivity of said wastewater containing high-concentration boron and reducing power consumption during said electrocoagulation procedure.

8. The treatment method of wastewater containing high-concentration boron as claimed in claim 4, wherein a power source adopted in said boron-removing electrocoagulation tank is a direct-current power source with 30˜1000V, and said direct-current is from an energy storage battery or solar power.

9. The treatment method of wastewater containing high-concentration boron as claimed in claim 4, wherein said boron-removing electrocoagulation tank further has an electrode, and said electrode is pure aluminum, nickel, iron or an alloy consisted of pure aluminum, nickel and iron.

10. The treatment method of wastewater containing high-concentration boron as claimed in claim 4, wherein when said bottom ash is provided with an amount of 100˜500 g/L, an absorbing period of 20˜180 minutes is required.

11. The treatment method of wastewater containing high-concentration boron as claimed in claim 4, wherein said filtering tank further has ultrafine hollow fibers with less than 0.5 micron as a filtering material, which is used for purifying said wastewater after being performed said electrocoagulation procedure.

12. The treatment method of wastewater containing high-concentration boron as claimed in claim 4, wherein when said fly ash is provided with an amount of 100˜500 g/L, an absorbing period of 20˜180 minutes is required.

13. The treatment method of wastewater containing high-concentration boron as claimed in claim 4, wherein said binder is cement.
